(19) United States
(12) Patent Application Publication
(10) Pub. No.: US 2005/0132602 A1
(43) Pub. Date: Jun. 23, 2005

(54) Laundry separator for compartmentalized drying

(75) Inventors: Seong Hai Jeong, Changwon-si (KR); Soo Won Park, Changwon-si (KR); Ju Han Yoon, Changwon-si (KR); Seong Kyu Kim, Sancheong-gun (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 10/959,319

(22) Filed: Oct. 7, 2004

(30) Foreign Application Priority Data
Dec. 18, 2003 (KR) 2003-93200

(51) Int. Cl. F26B 19/00; F26B 11/02

(52) U.S. Cl. 34/602; 34/109

(57) ABSTRACT

A laundry separator for compartmentalized drying is loaded in the drum of a dryer, or in the drum of a washer having a drying function, as an accessory enabling simultaneous drying of laundry sorted according to type, color, and so on. The laundry separator for compartmentalized drying, includes at least one divider for detachable installation in a drum for drying laundry, wherein the at least one divider partitions an inner space of the drum into a plurality of spaces.

This application claims the benefit of Korean Application No. P2003-093200, filed on Dec. 18, 2003, which is hereby incorporated by reference.

### BACKGROUND OF THE INVENTION

1. Field of the Invention

The present invention relates to a dryer accessory, and more particularly, to a laundry separator for compartmentalized drying, which is loaded as an accessory in a dryer or a washer having a drying function.

2. Discussion of the Related Art

Generally speaking, a dryer or washer having a drying function is an apparatus for drying objects such as a laundry contained in a drum by supplying hot air to the drum. To enhance drying performance, a plurality of lifters are provided within the drum, as shown in FIG. 1 illustrating the drum of a general dryer or washer-dryer. Here, the lifters and drum are individually manufactured, and then the lifters are installed inside the drum.

Referring to FIG. 1, a plurality of locking members 3 (e.g., screws) is used to install a plurality of lifters 2 on an inner surface of a drum 1. As an alternative, the lifters 2 may be formed by pressing the drum 1 to deform its inner circumferential surface.

In drying an object to be dried, the corresponding object held within the drum 1 is lifted by the lifters 2 up to a predetermined height and then dropped. The object is easily exposed to hot air supplied to the drum 1 to be evenly dried, thereby enhancing drying efficiency.

However, in the above-constructed dryer or washer having the drying function, it is impossible to dry various kinds of drying objects or various colored drying objects at the same time. For instance, some kinds of drying objects are easily decolorized. If such a kind of a drying object is dried together with a white drying object, the white drying object tends to get dyed. In order to overcome such a problem, drying objects should be sorted according to types and colors to be separately dried, which is time consuming and inconvenient and wastes electricity.

### SUMMARY OF THE INVENTION

Accordingly, the present invention is directed to a laundry separator for compartmentalized drying that substantially obviates one or more of the problems due to limitations and disadvantages of the related art.

An object of the present invention, which has been devised to solve the foregoing problem, lies in providing a laundry separator for compartmentalized drying, which is loaded in a drum of a dryer or washer having a drying function and by which various type or colored drying objects are sorted to be dried at the same time.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, a laundry separator for compartmentalized drying, includes at least one divider for detachable installation in a drum for drying laundry, wherein the at least one divider partitions an inner space of the drum into a plurality of spaces.

In another aspect of the present invention, a laundry separator for compartmentalized drying includes a shaft for being detachably installed lengthwise in a drum of an appliance having a drying function, and a plurality of dividers radiating from the shaft to partition an inner space of the drum into a plurality of spaces.

The at least one divider is provided radially with respect to the drum. And, the at least one divider has a distal end for coupling to a lifter protruding inwardly from the drum.

Preferably, the at least one divider has a multitude of apertures for allowing airflow between the plurality of spaces. Herein, the apertures extend radially from the shaft.

Preferably, the at least one divider has a length corresponding to an inner length of the drum. Herein, each divider has an axial length substantially equal to an interior space of the drum.

Preferably, the at least one divider has elasticity in a radial direction of the drum. And, the at least one divider has elasticity in a circumferential direction of the drum.

Preferably, when installed, the shaft is aligned with the central axis of the drum. Herein, the shaft includes a tube having an outer circumference, the dividers radiating from the outer circumference. The shaft has elasticity in a radial direction.

Preferably, the laundry separator may include a plurality of elastic members, each connecting an opposing side of the dividers, to reinforce elasticity of the dividers in a circumferential direction of the drum. Herein, each elastic member has a curved surface on a same central axis of the shaft. Each divider includes two sides forming a recess in a distal end for receiving a lifter.

Preferably, the dividers are configured as adjacent pairs, each pair forming a gap in which a lifter protruding from an inner surface of the drum can be fitted. The laundry separator may include a plurality of elastic members, each connecting an opposing side of the dividers, to reinforce a gripping force applied to the lifter. Herein, each elastic member has a curved surface on a same central axis of the shaft.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a cross-sectional diagram of a drum of a general dryer or washer-dryer;

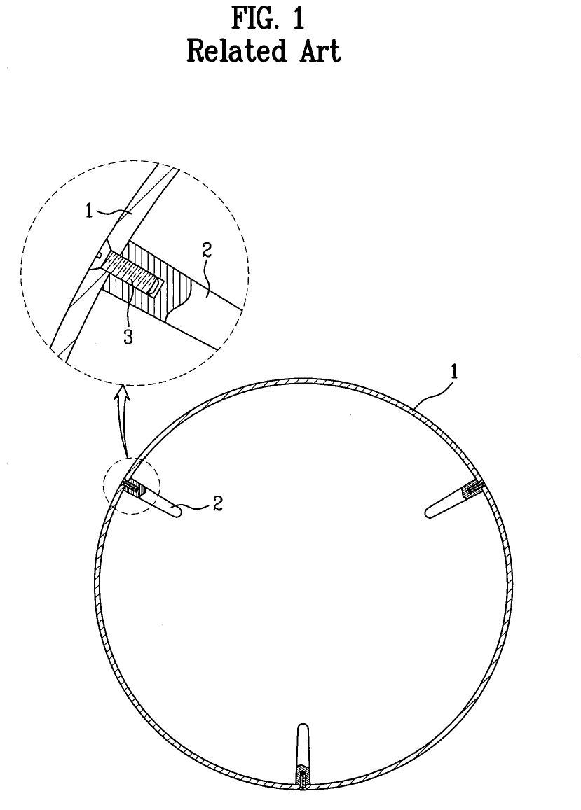

FIG. 2 is a cross-sectional diagram of a dryer in which a laundry separator according to the present invention is installed;

FIG. 3 is a perspective diagram of a laundry separator according to a first embodiment of the present invention;

FIG. 4 is a cross-sectional diagram of the laundry separator in FIG. 3 loaded in a drum;

FIG. 5 is a perspective diagram of a laundry separator according to a second embodiment of the present invention; and

FIG. 6 is a perspective diagram of a laundry separator according to a third embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Throughout the drawings, like elements are indicated using the same or similar reference designations where possible.

A laundry separator according to the present invention can be installed and used in an exhaust-type dryer, condensing-type dryer, washer/dryer, or the like. In the exhaust type dryer, external air is heated to be supplied to a drum and humid air having dried a drying object within the drum is discharged. In the condensing type dryer, air, which is humid after having dried a drying object within a drum, is condensed by a condenser to lower the humidity and is then heated to be re-supplied to the drum. The laundry separator according to the present invention as described herein is to be installed in the exhaust type dryer as an example but is appropriate for installation in any appliance having a drum for performing a drying function.

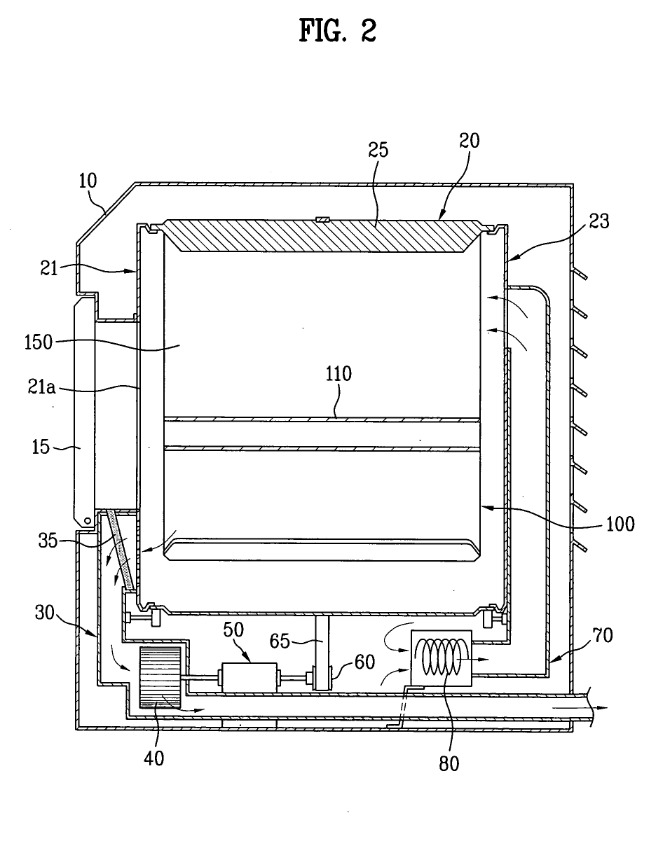

Referring to FIG. 2, a drum 20 is rotatably provided within a cabinet 10 of a dryer. The drum 20 has a cylindrical shape, and a plurality of lifters 25 protrude from an inner surface of the drum 20. The lifter 25 and the drum 20 are separately manufactured. Hence, the lifter 25 is attached to the inside of the drum 20 later. Instead, the lifters 25 may be integrally formed with the drum 20. A front panel 21 and rear panel 23 are respectively mounted on an open front side and open rear side of the drum 20, which is rotatably supported by the front and rear panels 21 and 23 during dryer operation. That is, while the dryer is operated, the drum is rotated but the front and rear panels 21 and 23 remain stationary. An opening 21a is provided to the front panel 21, and a door 15 is installed on the front side of the cabinet 10 to open/close the opening 21a. An exhaust duct 30 is connected to the front panel 21. Hence, the interior of the drum 20 communicates via the exhaust duct 30 with an external environment with respect to the cabinet 10. A fan 40 for expelling the air in the drum 20 and a filter 35 filtering the air expelled by the fan 40 are provided within the exhaust duct 30. The fan 40 is rotated by a motor 50 provided within the cabinet 10 to rotate both the fan 40 and the drum 20. For this, the motor 50 includes a pair of shafts respectively connected to the fan 40 and a pulley 60 connected to the drum 20 via a belt 65. Though not specifically shown, the motor 50 may rotate the fan 40 only. An air inlet duct 70 is connected to the rear panel 23 to enable the inside of the drum 20 to communicate with an external environment. As the fan 40 rotates to discharge the air within the drum 20 outside via the exhaust duct 30, external air is supplied into the drum 20 via the air inlet duct 70. A heater 80 is installed in the air inlet duct 70 to supply hot air into the drum 20.

A laundry separator 100 according to the present invention is installed in the drum 20. The laundry separator 100 according to the present invention is detachably installed in the drum 20 and partitions an inner space of the drum 20 into a plurality of partitioned spaces. Hence, a user puts drying objects sorted according to types and colors in a plurality of the spaces partitioned by the laundry separator 100 and then operates the dryer to dry the drying objects of various colors and types at the same time.

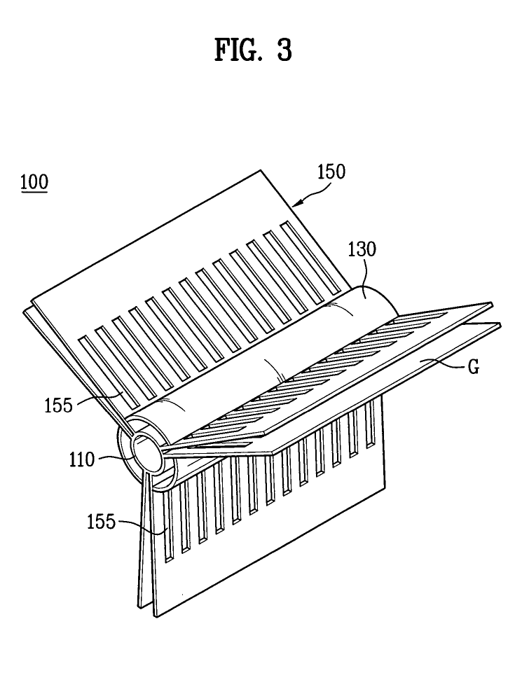

Referring to FIG. 3, a shaft 110 and a plurality of dividers 150 are provided to the laundry separator 100 according to the present invention. The shaft 110 is inserted along a length direction of the drum 20, and a plurality of the dividers 150 extend from the shaft 110 to partition an inner space of the drum 20 into a plurality of partitioned spaces. In the embodiment shown in FIG. 3, the shaft 110 includes a long tube that is hollow. Preferably, the shaft 100 has the same length of a front-to-rear length of the drum 20 and the same central axis of the drum 20. Each of the dividers 150 extends out of an outer circumference of the tube in a radial direction of the drum 20.

The shaft 110 may be formed of a substantially rigid material but may be imparted with some elasticity in its radial direction. Each of the dividers 150 extending from the outer circumference of the shaft 110 in the radial direction of the drum 20 may have elasticity in the radial direction of the drum 20. The dividers 150 extend from the circumference of the shaft 110 in the same direction of the shaft 110 or drum 20. Preferably, each of the dividers 150 has the same length of the shaft 110 and is installed to be nearly in contact with both front and rear insides of the drum 20 when the laundry separator 100 is loaded in the drum 20. Then, the inner space of the drum 20 is partitioned into a plurality of spaces by the laundry separator 100 so that drying objects respectively held in the partitioned spaces are not loaded together.

A multitude of apertures 155 are provided to each of the dividers 150 so that air can pass through the apertures 155. Each of the apertures 155 is formed long in the radial direction of the drum 20, for example. Once the apertures 155 are provided to the dividers 150, hot air supplied to the drum 20 flows throughout the spaces created by the dividers 150 via the apertures 155, to uniformly dry the drying objects in each space.

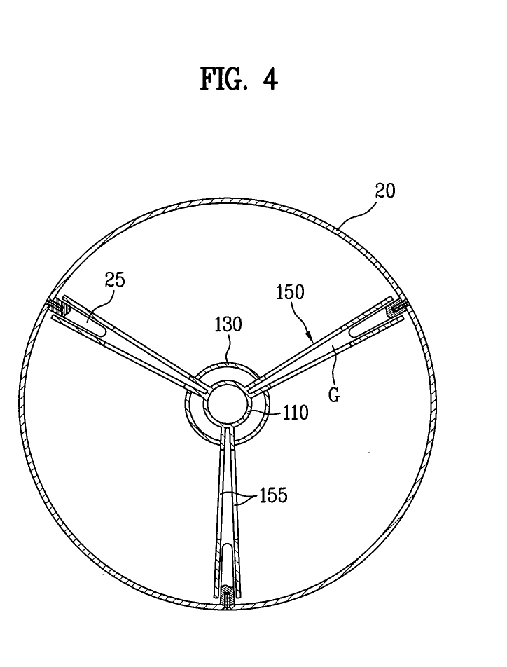

As shown in FIG. 4, an outer end of each of the dividers 150 is coupled to the corresponding lifter 25 to be fixed thereto. For this, the dividers 150 are arranged in adjacent pairs so that the corresponding lifter 25 can be fitted in a gap G exiting between the corresponding pair of the dividers 150 to install the laundry separator 100 according to the present invention in the drum 20 stably and securely. The distance, i.e., the gap G, between the sides of an adjacent pair of dividers 150 is preferably set smaller than the thickness of any lifter 25, so that the adjacent pair of dividers 150 provides a gripping force acting on the lifter. For this, the laundry separator 100 is provided with an elastic member 130 between opposing sides of each adjacent pair of dividers 150 to provide the respective dividers 150 with elasticity in a circumferential direction of the drum 20. Specifically, the elastic member 130 is provided to connect two dividers 150, thereby reinforcing the gripping force of the dividers 150, to fit onto the lifters securely and firmly, with little or no incidental movement, and thereby support a load of wet laundry and prevent excess noise, such as rattling or knocking, during dryer operation. The elastic member 130 has a circular cross-section on the same central axis of the shaft 110.

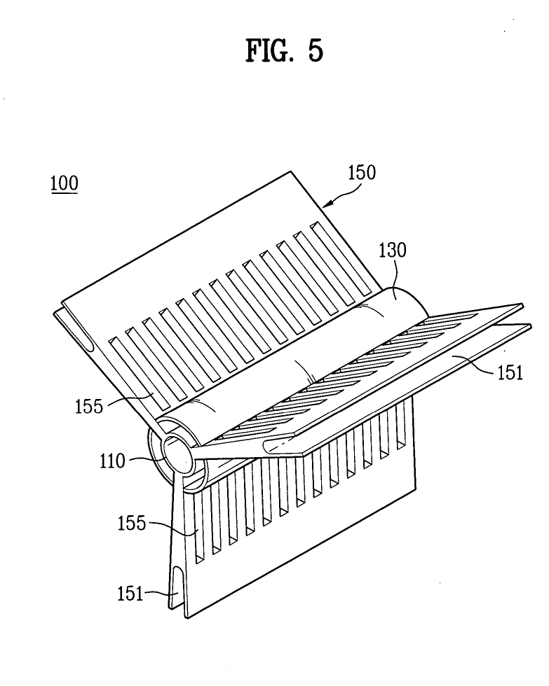

In the embodiment of FIG. 5, the dividers 150 of the laundry separator 100 according to the present invention are structurally modified to provide a recess 151 formed in the distal end of each of a plurality of dividers 150′ for receiving a lifter 25. The lifters 25 are respectively fitted in the recesses 151 of each divider 150′, whereby the laundry separator 100 can be stably loaded in the drum 20.

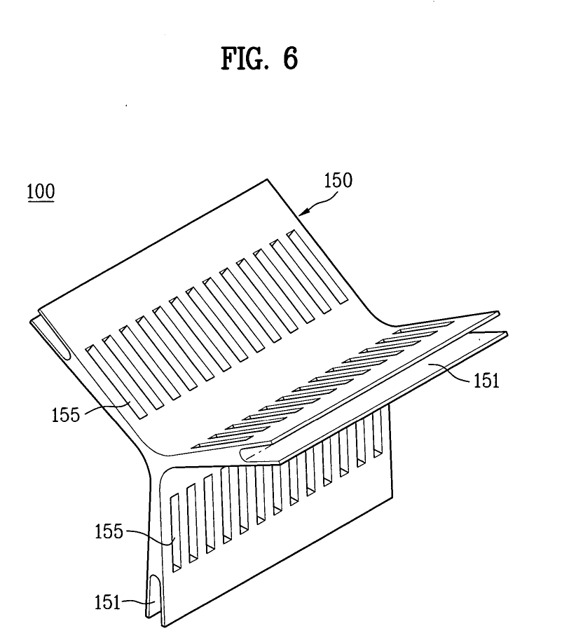

In the embodiment of FIG. 6, a plurality of the dividers 150□are centrally connected without a shaft 110 or an elastic member 130. In this case, the axis of the laundry separator 100 is defined by the circumference of the drum 20 as determined by the location of the mounting lifters.

Meanwhile, although not specifically shown in the drawings, a further embodiment of the laundry separator of the present invention may include a structurally modified shaft, in which the diameter of the shaft is large enough to provide an additional space for accommodating laundry to be dried separately from that held in the spaces partitioned by the dividers.

Moreover, rather than the dividers of the above-described embodiments, which radiate from a central point along the full length of the shaft to provide a plurality of partitioned spaces in the shape of wedges, the laundry separator of the present invention could be provided with dividers that radiate from a plurality of points along the length of the shaft to provide a plurality of alternatively partitioned spaces in the shape of wheels.

In using the laundry separator 100 for drying various objects of differing in color and/or type, the laundry separator 100 is installed within the drum 20 so that the shaft 110 is located on the central axis of the drum 20. In doing so, a plurality of the dividers 150 can be elastically deformed in the same radial direction of the shaft 110 or drum 20 and their circumferential directions, respectively, whereby a user is facilitated to install the laundry separator 100 within the drum 20.

After completion of installing the laundry separator 100, the lifter 25 of the drum 20 is fitted in the gap G between adjacent dividers 150 or in the recess 151 formed at the distal end of each divider 150′, thereby being stably fixed thereto. Thus, while the laundry separator 100 is stably loaded in the drum 20, the drying objects sorted according to types and/or colors are placed in the spaces partitioned by the dividers 150 as desired.

With the laundry separator 100 thus installed, the door 15 is closed and the dryer is then actuated. The drum 20 is rotated by the motor 50, pulley 60, and belt 65 so that the drying objects held in the respective spaces partitioned by the laundry separator 100 are repeatedly lifted upward to fall within the respective partitioned spaces by the rotational force of the drum 20. Meanwhile, the fan 40 rotates and the heater 80 heats the air. The heated air is supplied to the drum 20 via the air inlet duct 70, as the air within the drum 20 is discharged via the exhaust duct 30.

The heated air supplied to the drum 20 flows in the spaces partitioned by the dividers 150 to dry the drying objects. In doing so, the heated air can travel to other spaces via the apertures 155 provided to the dividers 150, thereby uniformly drying the drying objects in each of the partitioned spaces.

The air, which becomes humid air after drying the drying objects within the drum 20, is then discharged outside via the exhaust duct 30. In doing so, particles contained in the humid air are removed by the filter 35 so that clean air can be discharged.

If no sorting of the drying objects is desired, the laundry separator 100 is removed from the drum 20. In doing so, the dividers 150 are elastically deformed in the radial and circumferential directions of the shaft 110 and drum 20, to facilitate the removal of the laundry separator 100 from the drum 20.

As described above, the laundry separator according to the present invention is detachably installed in the drum of the dryer or washer/dryer to partition the inner space of the drum 20 into a plurality of spaces. Accordingly, a user puts the drying objects sorted according to colors and/or types in the partitioned spaces within the drum, respectively, whereby the entire drying objects can be dried at the same time. Therefore, the drying objects can be easily dried, the corresponding drying time is shortened, and power consumption can be considerably saved.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

1. A laundry separator for compartmentalized drying, comprising at least one divider for detachable installation in a drum for drying laundry, wherein the at least one divider partitions an inner space of the drum into a plurality of spaces.

2. The laundry separator as claimed in claim 1, wherein the at least one divider is provided radially with respect to the drum.

3. The laundry separator as claimed in claim 1, wherein the at least one divider has a distal end for coupling to a lifter protruding inwardly from the drum.

4. The laundry separator as claimed in claim 1, wherein the at least one divider has a multitude of apertures for allowing airflow between the plurality of spaces.

5. The laundry separator as claimed in claim 1, wherein the at least one divider has a length corresponding to an inner length of the drum.

6. The laundry separator as claimed in claim 1, wherein the at least one divider has elasticity in a radial direction of the drum.

7. The laundry separator as claimed in claim 1, wherein the at least one divider has elasticity in a circumferential direction of the drum.

8. The laundry separator as claimed in claim 1, wherein the at least one divider comprises two sides forming a recess in a distal end for receiving a lifter.

9. The laundry separator as claimed in claim 1, wherein the at least one divider is configured as an adjacent pair forming a gap in which a lifter protruding from an inner surface of the drum can be fitted.

10. A laundry separator for compartmentalized drying, comprising:
a shaft for being detachably installed lengthwise in a drum of an appliance having a drying function; and
a plurality of dividers radiating from the shaft to partition an inner space of the drum into a plurality of spaces.

11. The laundry separator as claimed in claim 10, wherein, when installed, the shaft is aligned with the central axis of the drum.

12. The laundry separator as claimed in claim 10, wherein each divider has an axial length substantially equal to an interior space of the drum.

13. The laundry separator as claimed in claim 10, wherein each divider has a distal end for connecting to a lifter protruding from an inside of the drum.

14. The laundry separator as claimed in claim 10, wherein each divider comprises two sides, each side having a plurality of apertures for ventilation.

15. The laundry separator as claimed in claim 14, wherein the apertures extend radially from the shaft.

16. The laundry separator as claimed in claim 10, wherein the shaft comprises a tube having an outer circumference, the dividers radiating from the outer circumference.

17. The laundry separator as claimed in claim 16, wherein the shaft has elasticity in a radial direction.

18. The laundry separator as claimed in claim 10, further comprising a plurality of elastic members, each connecting an opposing side of the dividers, to reinforce elasticity of the dividers in a circumferential direction of the drum.

19. The laundry separator as claimed in claim 18, wherein each elastic member has a curved surface on a same central axis of the shaft.

20. The laundry separator as claimed in claim 10, wherein each divider comprises two sides forming a recess in a distal end for receiving a lifter.

21. The laundry separator as claimed in claim 10, wherein the dividers are configured as adjacent pairs, each pair forming a gap in which a lifter protruding from an inner surface of the drum can be fitted.

22. The laundry separator as claimed in claim 21, further comprising a plurality of elastic members, each connecting an opposing side of the dividers, to reinforce a gripping force applied to the lifter.

23. The laundry separator as claimed in claim 22, wherein each elastic member has a curved surface on a same central axis of the shaft.
